(19) United States
(12) Patent Application Publication
(10) Pub. No.: US 2023/0288344 A1
(43) Pub. Date: Sep. 14, 2023

(54) APPARATUS AND METHOD FOR INSPECTING CONTAINERS

(71) Applicant: KRONES AG, Neutraubling (DE)

(72) Inventors: Anton NIEDERMEIER, Offenstetten (DE); Stefan SCHOBER, Tegernheim (DE)

(21) Appl. No.: 18/016,255

(22) PCT Filed: Jun. 30, 2021
(86) PCT No.: PCT/EP2021/068100

§ 371 Date: Jan. 13, 2023

(30) Foreign Application Priority Data
Jul. 13, 2020 (DE) 10 2020 118 470.0

(51) Int. Cl. G01N 21/90

(52) U.S. Cl. CPC G01N 21/9072; G01N 2021/8887

(57) ABSTRACT

Apparatus for inspecting containers, having a transport device which transports the containers along a predetermined transport path, and having an inspection device for inspecting the containers, wherein this inspection device has an image recording device which is configured for recording a spatially resolved image of a bottom of the container. The apparatus includes an image evaluation device which is configured for evaluating the image recorded up by the image recording device, wherein this image evaluation device enables a distinction between images of those containers which have foreign bodies in their interior and those containers which have foreign bodies on an outer surface of the bottom.

The present invention relates to a method for inspecting containers and in particular also for inspecting container bottoms. Such bottom inspections have been known in the prior art for a long time. It is common practice for the containers to be transported bottom-free and to have their bottoms blown off before the actual inspection. This blowing off removes foam residues from the bottom of the containers.

More precisely, this bottom blow-off or also a bottom suction is installed upstream of the bottom inspection. It has the object of freeing the underside of the container bottom and its immediate surroundings from drops, foam, label residues and the like. The aim is to achieve more precisely that only potential contamination remains inside the container bottoms. These remaining contaminations can be detected by the bottom detection and subsequently the container can be rejected. If the rejected containers are collected, it can be decided by the operator of the system afterwards or also within the scope of an automatic process, based on the defect condition, whether the container is sent to manual pre-cleaning, automatic cleaning or destruction.

The production output of a bottom inspection is between 6,000 and 100,000 containers per hour, in particular between 16,000 and 85,000 containers per hour. The cleaning function must therefore work thoroughly and quickly. Therefore, in the prior art, an actuator is used, for example a blower nozzle pulsed or in continuous operation. In addition, a suction device could also be provided.

The bottom blow-off is necessary in the state of the art because the detection of contamination does not allow a clear separation of the typical disturbances in the outer area from the contamination inside the bottom. However, this distinction would be important. It must be taken into account that the detection performance must always be seen in connection with the false rejection. Typical disturbing influences in the outer area are adhering water drops, foam bubbles, fogged or partially fogged bottom, grinding marks caused by the cleaning process and the like. These disturbances are, if they are the cause of the container rejection, considered as false rejections.

An example of such a bottom blow-off is described in DE 20 2007 007 373 U1.

Relevant soiling, however, is soiling that occurs inside the containers, such as crumpled paper or foil, cigarette filters and the like.

A reliable detection of the contamination or foreign objects with an acceptable false rejection is only possible with a powerful bottom blow-off. A reliable detection means that more than 95%, preferably more than 97%, preferably more than 98.5% and particularly preferably more than 99.8% of the faults are detected. An acceptable false rejection is less than 0.1, preferably less than 0.05 or even better less than 0.03% of the containers produced. This means that even with a maximum false rejection of 0.05%, at most every 2,000th good production container should be classified as bad.

With a daily production of approximately 150,000 containers up to 2 million containers, it becomes understandable how important this false rejection figure is with simultaneous reliable defect detection. If the production speed and the fact that every container is inspected are taken into account, it quickly becomes understandable that the choice of suitable evaluation methods is limited and thus blow-off has been without alternative up to now.

Bottom blow-off, on the other hand, has numerous disadvantages. For example, bottom blow-off consumes air or other media or obtains its primary energy from electricity to generate air or air streams. The energy consumption is not insignificant.

The blow-off should or must work correctly, so care must be taken to ensure the correct functional distance. If an actuator is only operated intermittently, as is the case with a pulsed blow nozzle, for example, the time of the action must be synchronised with the moving container. If different container sizes and shapes are processed in the production types, the cleaning process must be adapted to the new conditions. This can lead, for example, to a mechanical adjustment or a change in the synchronisation point.

A change of parameters may also be necessary when changing the type. Furthermore, the function of the unit must be checked regularly and is subject to wear, for example its valve. In addition, the blow-off unit requires space along the transport path. Furthermore, certain functions, such as continuous blowing when the machine is at a standstill or when the machine is opened, must be switched off, and blowing off is also cost-intensive.

The present invention is therefore based on the object of avoiding or alleviating the abovementioned disadvantages of blow-off.

According to the invention, this is achieved by the subject matters of the independent patent claims. Advantageous embodiments and further developments are the subject of the subclaims.

An apparatus for inspecting containers according to the invention comprises a transport device which transports the containers along a predetermined transport path and/or in a predetermined transport direction, and an inspection device for inspecting the containers, wherein said inspection device comprising an image recording device which is suitable and intended for recording a spatially resolved image of a bottom of the container.

According to the invention, the apparatus comprises an image evaluation device which is suitable and intended for evaluating the image recorded by the image recording device, wherein said image evaluation device enables a distinction between images of those containers which have foreign bodies in the interior and those containers which have foreign bodies on an outer surface of the bottom.

It is therefore proposed that the blow-off device can be replaced by means of an image evaluation device or an improved evaluation device. In doing so, the applicant has found that a user can usually recognise with the naked eye, when looking at an image taken of the container, whether there is a defect, or a foreign body inside the container, or an object on the outer wall, such as foam or foam residue. The user can usually also tell the nature of the foreign object by looking at an image.

The user can use the experience that, for example, foam residues on the outer wall of the container give a different visual impression than bodies inside the container. For example, foam residues on the outer wall of the container cast bubbles which are also recognisable in an image and can thus be easily identified. Within the scope of the invention, it is thus prom posed that the evaluation device also determines, within the scope of the evaluation, on the basis of the image, which type of defects or faults have been recorded.

In a possible embodiment, it would be possible for the image recording device to record two images, wherein the focus of the image is placed once on the upper side of the container bottom and once on its underside. In this way, the sharpness of the image makes it possible to recognise whether the corresponding disturbance or a foreign body is inside or outside the container. In addition, it would also be possible for the focus of the image recording device to be placed on the upper side of the bottom or the underside. Here, too, it would be possible to differentiate according to the sharpness of the individual objects in the image.

In addition, it would be possible, for example, for the evaluation device to search for characteristic image segments which are characteristic, for example, of foam residues adhering to the container. For example, foam residues throw bubbles that appear in an image as circular structures. When such image segments are identified, the evaluation device can conclude that foreign bodies are located on the outer surface of the bottom.

This enables the apparatus to distinguish between such foreign objects that are present on the outer surface of the bottom and such foreign objects that are present inside the container. Typical foreign objects inside the container are, for example, relatively large objects such as compressed crown caps, crumpled paper or foil, cigarette filters, wire (paper clips and the like), safety rings, straws, pieces of wood, spatulas (from popsicles). Medium-sized foreign objects that can be found inside the container can have an extension of a few millimetres to just under one centimetre. They are in the order of magnitude of the water drops adhering to the outside, such as shards of glass, small paper (labels), scraps or pieces of foil, insects, mould stains and the like. Smaller defects of one millimetre to a few millimetres are, for example, very small pieces of paper or foil, individual spots of mould, small insects, larvae or glass splinters.

The classification of these disturbances or foreign bodies or also faults shows that large objects are easily distinguishable from the external disturbances or the externally adhering objects. However, the difference between the medium-sized faults and the external disturbances is somewhat more difficult to manage. In the case of smaller foreign objects, there is a risk that they are visually embedded in an interference location.

Furthermore, it would be possible for the evaluation device to compare the recorded images with reference images, which are recorded for certain types of foreign bodies, for example. On the basis of these comparisons, the evaluation device can determine whether the image depictions are of a foreign body that is in contact with the outer surface of the container or of a foreign body that is located inside the container.

Preferably, the evaluation device carries out an automatic evaluation. As mentioned above, it is possible for the image recording device to record only one image, but it would also be possible for several images to be recorded.

Preferably, an image is recorded by the image recording device during transport of the container.

It is thus proposed, as described in more detail below, to replicate or mimic the human experience of viewing such images. Preferably, the apparatus comprises a memory device in which reference images of disturbances are stored. Furthermore, a comparison device may be provided which compares recorded images with reference images.

In a particularly preferred embodiment, the apparatus does not have a bottom blow-off, in particular one that is arranged in front of the inspection device. In a further preferred embodiment, the transport device transports the containers individually.

In a further preferred embodiment, the image recording device is arranged above the containers to be inspected and in particular above their mouths. In this way, it can be achieved that the actually relevant foreign bodies located inside the container are in any case located above the foreign bodies located outside the container, such as foam residues, and are thus captured in the camera image in any case. Preferably, the containers are unfilled or empty containers.

In a further preferred embodiment, the imaging recording device observes or enables observation of the bottom of the container through a mouth of the container.

In a further preferred embodiment, the apparatus has an illumination device for illuminating the containers. Preferably, this illumination device is arranged below the containers so that the containers are inspected using the transmitted light method. Preferably, the container or the transport path of the containers is arranged between the image recording device and the illumination device.

In a further preferred embodiment, the illumination device is a pulsed illumination device. Advantageously, this illumination device is synchronised with the image recording device. In a further preferred embodiment, the illumination device is also synchronised with the transport device of the containers. This means that the images are always taken in a certain position of the containers.

Preferably, therefore, a triggering device is also provided which triggers the illumination device and/or the image recording device.

In a further preferred embodiment, the transport device is suitable and intended for transporting the containers at least in sections bottom-free. This means that the bottom of the containers remains free during their transport and can thus also be observed using the transmitted light method. However, it would also be possible for the containers to be transported on a floor or a base that itself acts as an illumination device.

An example of such a transport device that transports the containers bottom-free are, for example, side belts that pick up the containers between them and transport them in this way.

In a further preferred embodiment, the image evaluation is suitable and intended for identifying optically perceptible characteristic properties of foreign bodies arranged on the outer surface of the containers. For example, as mentioned above, air bubbles or foam can be identified.

It is therefore proposed that, as mentioned above, the blow-off function is compensated for by an evaluation using new efficient algorithms or procedures to ensure a sufficient estimation or discrimination of the typical outside interference versus their inside pollution.

Interestingly, the human observer has always been able to tell from the camera image whether it is a disturbance on the outside or a foreign object on the inside. Only the most diverse evaluation methods have not been able to distinguish the situation accurately until today. The bottom blow-off is thus replaced or completely abandoned by a simple system without blowing air media and/or media consumption.

In a further advantageous embodiment, the apparatus has a rejection device which is suitable and intended for rejecting containers from the product stream of containers transported by the transport device on the basis of a value and/or result output by the evaluation device. In particular, such containers are rejected by which the evaluation device detecting a foreign body inside the container. In addition, containers in which the evaluation device detects a foreign body on the outer surface and in particular on the outer wall of the bottom are advantageously not rejected.

In a further advantageous embodiment, the apparatus comprises, along the transport path upstream with respect to the inspection means, a contaminant removal device suitable and intended to remove contaminants present on the outer surface of the bottom portion of the container, wherein said contaminant removal device comprising an element mechanically contacting the container.

In contrast to, for example, a blow-off, it is therefore proposed here that a cleaning element is provided which mechanically removes contaminants from the container. Preferably, this contamination removal device is selected from a group of elements that includes peel-off lips, brushes, brush rollers or the like.

It is preferably possible that this contamination removal device is moved. It is possible that this element is moved in relation to the transported containers, for example by performing an additional circular movement. The relative speed between this contamination removal device and the bottom of the container can be 5 or even greater than the transport speed, and the movement can also be arranged in any orientation relative to the transport direction. Furthermore, the movement may also be a circular movement or may also be combined with the relative movement (between the container and the contamination removal device).

It is possible that this contamination removal device is carried along with the container for a certain distance. However, it is also possible that this contamination removal device is stationary.

This contamination removal device is used in particular to remove contamination that can impair the image recording of the bottom of the container to such an extent that foreign bodies possibly located above this contamination can no longer be detected.

In a preferred embodiment, the evaluation device is adapted in such a way that a detection of the bottom inspection can still recognise in a camera image or an image of the image recording device the typical manifestations of those disturbances or foreign bodies which still remain after a lip or brush in the outer area of the container bottom without blowing off.

However, it would also be possible that such disturbance variables or impurities can also be distinguished from real defects, i.e. in particular from foreign bodies inside the container.

In a further preferred method, however, it is also possible to completely omit cleaning processes outside the container.

In addition, however, it is also possible for the evaluation device to distinguish the typical disturbance variables from real faults even without a contamination removal device. In a further preferred embodiment, wiping or brushing of the container is completely omitted and/or only used for the purpose of rough cleaning of very large foreign bodies.

In a further preferred embodiment, cleaning by a contamination removal device is only used for the purpose of removing disturbance variables or foreign bodies in the outer area that are the same as those in the inner area, such as label residues, films or dirt. The reason for this is that such disturbances in the outer area are difficult to distinguish from corresponding disturbances or foreign bodies in the inner area. It is possible, for example, that label residues on the outer surface of the container are difficult to distinguish from label residues inside the container. Thus, care is taken here to ensure that such contaminants are removed from the outer area of the container. However, it would also be possible for the evaluation device to automatically trigger a rejection when such contaminations are detected, as it would then not be possible to ensure whether the foreign body is a foreign body adhering to the outside of the container or a foreign body adhering to the inside of the container.

In a further preferred method, the method for distinguishing external disturbance variables from internal foreign bodies can be implemented by means of artificial intelligence. In this case, it is possible that from the sub-area of machine learning derived from this, its sub-area can be deep learning.

In addition, the method described here for distinguishing the foreign bodies can also be selected from the field of the support vector machine.

In a further preferred embodiment, the method may also use information from a texture, shape description, correlation results from descriptive image processing to assist.

Preferably, the evaluation device uses a method known as deep learning (multi-layer learning). Deep learning refers to a machine learning method that uses artificial neural networks with numerous intermediate layers between an input layer and an output layer, thereby forming an extensive internal structure. This is a special method of information management. In contrast, a convolutional neural network, unlike a deep neural network, uses convolutional operations that are pushed over an input image. However, the use of a convolutional neuronal network method would also be conceivable.

For example, this can be based on an image recorded by the image recording device.

As mentioned above, the image recording device records a spatially resolved image, in particular an image that has a plurality of image pixels. It is possible that these individual pixels are weighted differently in the context of an evaluation.

A weighting of each of these pixels is learned as part of the deep neural network convolution operations. This can be done in a training mode, for example.

Since these convolution operations (which can also lead to different weights of the pixels) are pushed over the image, all pixels share the same convolution weights. This dramatically reduces the number of weights compared to a deep neural network in which one weight is learned per input pixel. It is therefore preferably suggested here that a certain weight is learned per input pixel.

If the weights of a convolution have been taught to recognise a certain feature, then this feature can be recognised at any position in the image. In this way, for example, certain characteristic optical features of an image, such as the bubbles from a foam formation, can be recognised at any position in the recorded image.

Therefore, if the weights of a convolution have been learned to recognise a certain feature, this feature can be recognised at any position in the image. This translational independence is a decisive advantage over a deep neural network without convolutions. In the present case, this is exactly what is used to recognise characteristic features of certain defects.

Within the scope of the evaluation, a training process can also be carried out, which teaches the evaluation device. Training data can originate from camera images that are taken during production and are automatically or manually provided with defect markings. These images can be reference images, so to speak, which show or have certain defects to be detected.

The camera image can be assigned to one or more defect classes. For example, it is possible that there is both a crown cork and a “straw” in a bottle. The camera image of this bottle would then be assigned to the two defect classes crown cork and straw.

Preferably, a total set of these training images is composed of the following groups:
images of faults, which customers usually want to recognise, the so-called error catalogues;
images of faults found by conventional image processing methods in real plants;
images of faults, which are not found by conventional image processing methods in real plants, but which are classified as faults by the plant operator;
synthetic faults from the expert's experience, for example by artificially inserting error patterns into real camera images;
images of good images, i.e. camera images that do not show any errors.

The marking of the errors (annotation) in the training data is carried out either manually or automatically. It is possible that the annotation either consists only of the assignment to one or more defect classes or can also include additional marking areas that localise each defect in a camera image.

The training data can be augmented by creating variants of the real camera images. This process is called augmentation. For example, rotations, shifts, scaling, mirroring, contrast changes or image cropping can be applied to real camera images to create artificial training examples.

Additional training examples improve the training process and allow the classifier to learn general features without giving too much weight to the individual appearance of the fault.

The learning or training of the deep neural network is carried out with a part of the training data or at least a part of the training data. Preferably, a verification of a classification performance can be carried out with a further part of the training data.

In this way, it can be achieved that the classifier does not learn the training data by heart and its real classification performance is measured on image data previously unknown to it.

Preferably, between 70% and 95% of the training data, preferably between 75% and 90%, is assigned to the training data and between 5% and 30%, preferably between 10% and 20% and preferably about 15% to the verification data.

Training of a classifier can preferably take place on-site in a machine. However, due to the high computing time and memory requirements, such training is preferably carried out in a development laboratory. The result of this training is the learned weights, which represent, for example as a file, the second component that defines the neural classifier.

Preferably, an interference step is performed within the scope of the embodiments. Input data in this interference step can be one or more camera images. The output data of the neural network can be, for example, numerical values that indicate the affiliation of the processed camera image to one or more trained classes. In addition, the output data can also be a segmentation that assigns certain image areas to certain defect classes. It is possible that the type of output is determined by a network architecture and/or the training procedure.

Due to the high data rate of typically up to 25 camera images per second and up to 50 different sensors, it is conceivable that the execution takes place on the target system directly in the plant. However, execution outside the inspection machine would also be possible here (for example as part of a cloud solution).

Interference in the machine requires suitable hardware, such as a powerful CPU; GPU, FPGA or dedicated hardware, such as VPU. The execution away from a CPU offers the advantage of being able to use the CPU power elsewhere. It is also conceivable and technically feasible to implement it in an image recording device or a camera itself. In addition, it would also be possible and desirable to carry out an execution on the FPGA of a frame grabber, which has so far only been used for image acquisition.

Furthermore, advantageous components of a neural network, a structural description and also the associated trained weights are transferred to a machine in order to be able to carry out an interference in the machine.

The present invention is further directed to a method for inspecting containers, wherein a transport device transports the containers along a predetermined transport path and an inspection device inspects the containers, wherein said inspection device comprises an image recording device which records at least one spatially resolved image of a bottom of the container. According to the invention, the image recorded by the image recording device is evaluated by means of an image evaluation device, wherein this image evaluation device distinguishes between images of those containers which have foreign bodies in their interior and those containers which have foreign bodies on an outer surface of the bottom.

A spatially resolved image is understood to mean in particular an image with a plurality of pixels or image points. It is therefore also proposed on the method side that foreign bodies located inside the container are distinguished from foreign bodies located on the outer surface of the container and in particular on a bottom of the container by means of an image evaluation device.

In a further preferred method, only those containers are rejected which have foreign bodies in their interior.

Further advantages and embodiments can be seen in the attached drawings.

In the Drawings:

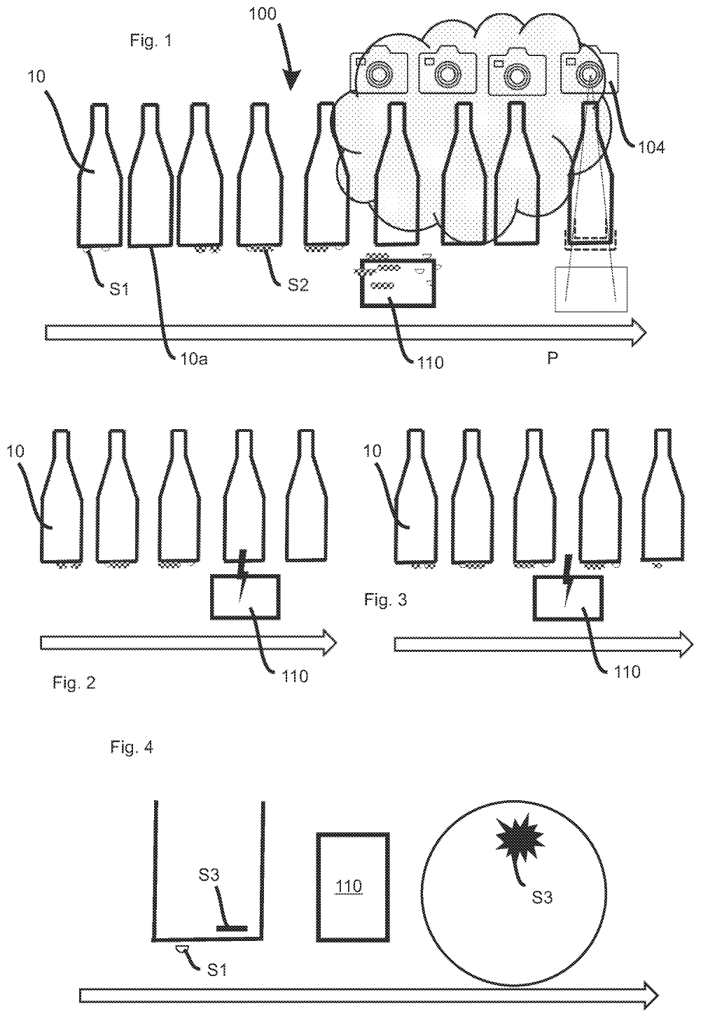

FIG. 1 shows a representation of an apparatus according to the state of the art;

FIG. 2 shows a representation with a synchronisation of a blow-off unit according to the state of the art;

FIG. 3 shows a representation of a faulty synchronisation in the state of the art;

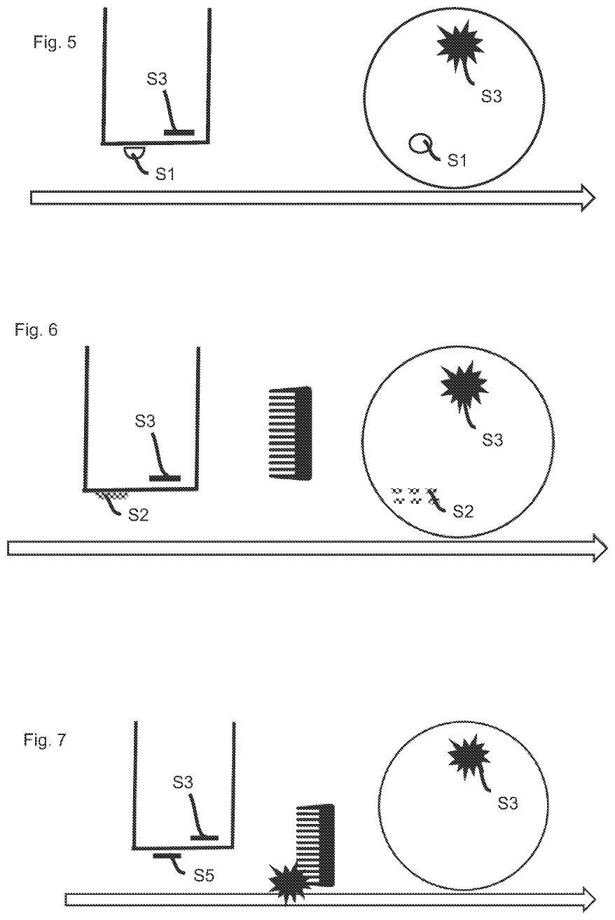

FIG. 4 shows a representation of images taken in the presence of a blow-off;

FIG. 5 shows a representation of recorded images without a blow-off;

FIG. 6 shows a representation of an advantageous embodiment of the invention with an additional cleaning device;

FIG. 7 shows a representation of the apparatus shown in FIG. 6 with a different type of dirt;

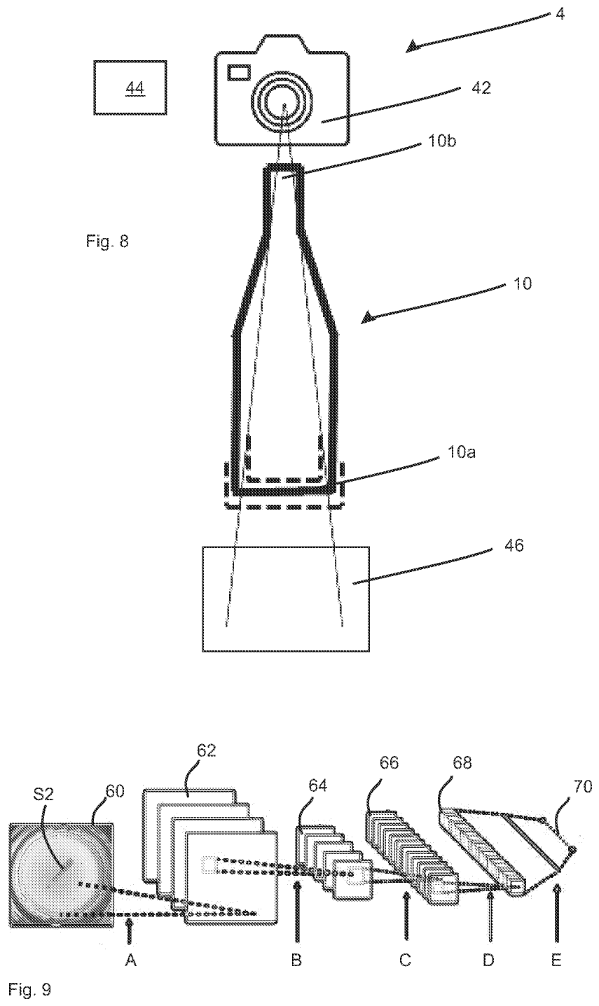

FIG. 8 shows a schematic illustration explaining the invention;

FIG. 9 shows a representation of a possible evaluation procedure.

FIG. 1 shows an apparatus 100 according to the prior art. Containers 10 are transported along a transport path P. The reference sign 110 indicates a blow-off device which blows off contamination, such as foam residues, from the bottoms of the containers. The reference sign 104 indicates an image recording device which records an image of the container bottoms through the mouths of the containers in order to detect contamination.

In the illustration shown in FIG. 2, a flash=time of the pulsed blow-off of a blow-off device 110 is correctly synchronised to the containers or their transport and thus triggers the cleaning in the correct position of the container.

In the illustration shown in FIG. 3, the pulse and the transport of the containers are not synchronous, so that cleaning is carried out at the wrong moment. As a result, the outer bottom of the container is still dirty downstream.

FIG. 4 shows the effect of a blow-off or suction on the corresponding foreign body. There is an impurity S1 and an impurity S3 on the container 10, wherein the impurity S3 is located inside the container. The blow-off 110 removes the outer contaminant S1, so that only the contaminant S3 appears in the camera image shown on the right.

In the situation shown in FIG. 5, no blow-off is provided, so that both the contamination S3 and the contamination S1 are present in the camera image. These are different in shape and can also be distinguished from each other by an evaluation device, as explained in more detail above.

In the situation shown in FIG. 6, a brush device is provided which partially removes a foam, in this case a contaminant S2, from the container. This produces the camera image shown in the partial image on the right.

In the situation shown in FIG. 7, a contaminant S5 is on an outside of the container and can be removed by the brushing device so that only the contaminant S3 appears in the camera image.

FIG. 8 illustrates a schematic representation of an apparatus according to the invention. Here again a bottle 10 is provided which is inspected through its mouth 10b by the image recording device 42. More precisely, the bottom 10a of the container is inspected here, which may have impurities both on its inside and on the outside.

The reference sign 46 indicates an illumination device which illuminates the bottom 10a of the container from below.

The reference sign 44 indicates the evaluation device that evaluates at least one or more images of the image recording device in order to conclude the type of contamination. If it is determined that contamination such as contamination S3 in FIG. 7 is present, the corresponding container is ejected. However, if only contamination such as contamination S5 is detected, a machine control (not shown) causes the container not to be discharged.

FIG. 9 illustrates a possible procedure for image evaluation. The starting point is an image 60 taken by the image recording device, for example of a bottom of the container. This image shows a foreign body S2, here in the form of a foam residue.

In a first step A, a convolution step (convolutions), feature maps 62 are created. In a further process step B, the sub-selection process, further (reduced) convolutions 64 are created or determined which, however, contain the respective image section. A further folding step C is carried out wherein a larger number of feature maps 66 are generated. In a process step D, a further sub-selection is made with a larger number of feature maps, so that finally a complete subdivision of the image is produced in step E and the result 70, which contains the searched feature, can be output.

Furthermore, the image 60 can also be taught in a varied manner, for example in different rotational positions, or also in enlarged or reduced forms of reproduction of the foreign body or the like.

The applicant reserves the right to claim all features disclosed in the application documents as essential to the invention, provided they are individually or in combination new compared to the prior art. It is further pointed out that the individual figures also describe features which may be advantageous in themselves. The skilled person immediately recognises that a certain feature described in a figure can also be advantageous without adopting further features from this figure. Furthermore, the skilled person recognises that advantages can also result from a combination of several features shown in individual figures or in different figures.

### LIST OF REFERENCE SIGNS

10 containers/bottle
10A bottom
10B mouth
42 image recording device
44 evaluation device
46 illumination device
60 image
62, 64, 66, 68 feature cards
70 output
100 apparatus
104 image recording device
110 blow-off device
S1-S3, S5 contamination
A-E method steps

1. An apparatus for inspecting containers, having a transport device which transports the containers along a predetermined transport path, and has an inspection device for inspecting the containers, wherein this inspection device having an image recording device which is configured for recording a spatially resolved image of a bottom of the container,
wherein
the apparatus comprises image evaluation device which is configured to evaluate the image recorded by the image recording device, wherein said image recording device enabling a distinction between images of those containers which have foreign bodies in their interior and those containers which have foreign bodies on an outer surface of the bottom.

2. The apparatus according to claim 1, wherein
the image recording device is arranged above the containers to be inspected.

3. The apparatus according to claim 2, wherein
the image recording is configured to record an image of the bottom of the container through a mouth of the container.

4. The apparatus according to claim 1, wherein
the apparatus comprises an illumination device configured to illuminate the bottom of the container.

5. The apparatus according to claim 1, wherein
the transport device is configured for transporting the containers at least in sections bottom-free.

6. The apparatus according to claim 1, wherein
the image evaluation device is configured for identifying optically perceptible characteristic properties of foreign bodies arranged on the outer surface of the containers.

7. The apparatus according to claim 1, wherein
the apparatus comprises a rejection device which is configured for rejecting containers from the product flow of the containers transported by the transport device on the basis of a value output by the evaluation device.

8. The apparatus according to claim 1, wherein
the apparatus comprises a contaminant removal devices arranged along the transport path upstream with respect to the inspection device, which is configured to remove contaminants located on the outer surface of the bottom portion of the container, wherein said contaminant removal device comprises an element mechanically contacting the container.

9. A method for inspecting containers, wherein a transport device transporting the containers along a predetermined transport path and an inspection device inspecting the containers, wherein this inspection device has an image recording device configured to record at least one spatially resolved image of a bottom of the container, wherein
the image recorded by the image recording device is evaluated by an image evaluation device, wherein said image evaluation device distinguishes between images of those containers which have foreign bodies in their interior and those containers which have foreign bodies on an outer surface of the bottom.

10. The method according to claim 9, wherein
only those containers are discharged which have foreign bodies in their interior.

11. The method according to claim 9, wherein
the image evaluation device uses a deep learning evaluation method.
